(19) United States
(12) Patent Application Publication
(10) Pub. No.: US 2023/0351329 A1
(43) Pub. Date: Nov. 2, 2023

(54) TOC-BASED SYSTEM FOR CONTINUOUSLY IMPROVING PRODUCTIVITY IN PROJECT MANAGEMENT

(71) Applicant: N&D TECHNOLOGIES, LLC, Hildale, UT (US)

(72) Inventor: David Timpson, Hildale, UT (US)

(21) Appl. No.: 18/140,298

(22) Filed: Apr. 27, 2023

Related U.S. Application Data
(63) Continuation of application No. 18/138,674, filed on Apr. 24, 2023.
(60) Provisional application No. 63/334,506, filed on Apr. 25, 2022.

(51) Int. Cl. G06Q 10/10

(52) U.S. Cl. CPC G06Q 10/103

(57) ABSTRACT

A system for managing projects to provide updated and real-time, or at least weekly, productivity of project and task performance. A system may include a series of inputs from a project that include budget, staffing, and other constraints. A processor may include pre-programmed logic sequences for providing efficient and effective feedback of project performance while also providing updated information of throughput, capacity, budget, and the opportunities to improve each. The system may require user feedback and updates in order for the system to optimize the results to the user. The system may be accessible by a staffer, supervisor, manager, customer, client, owner, or any other individual necessary for the project or the task.

### CROSS-REFERENCE TO RELATED APPLICATION

This application is a continuation of U.S. application Ser. No. 18/138,674, filed Apr. 24, 2023, titled TOC-BASED SYSTEM FOR CONTINUOUSLY IMPROVING PRODUCTIVITY IN PROJECT MANAGEMENT (“the '674 Application”) which claims priority to the Apr. 25, 2022 filing date of U.S. Provisional Patent Application No. 63/334,506, titled SYSTEM FOR PRODUCING INCREASED PRODUCTIVITY IN PROJECT MANAGEMENT (“the '506 Provisional Application”). The entire disclosure of the '674 Application and '506 Provisional Application are hereby incorporated herein.

### TECHNICAL FIELD

This disclosure relates generally to increased productivity and efficiency in project management and measuring project value in a more effective way than current practices. More specifically, this disclosure relates to construction management methods and systems in a computer readable medium that implements TOC-based project management to boost productivity in environments lacking schedule control.

### BACKGROUND

The management of projects, i.e., project management, has been a focus for continuous improvement in many industries for decades. Project-based industries are distinguished from production-based industries because of the variation that exists within the individual tasks (and strings of tasks) of the project; variation in task completion time is minimal in production environments and can be significantly large in project environments. Since the 1990's, thousands of software applications have been developed and implemented primarily to improve resource performance in the execution and completion of projects and to achieve predictable completion schedules. And yet to date, the software applications have been used to improve the detail and complexity of cost accounting and have not facilitated the improvement in resource performance.

Theory of Constraints (TOC) is a Management Science developed by Dr. Eliyahu Goldratt in the 1980's along with a philosophy to change the prioritization of management attention from the cost paradigm to the Throughput (value) paradigm. Dr. Goldratt led a significant change for improvement in many industries, primarily manufacturing and distribution, with a growing number of TOC implementers for the past thirty plus years. The implementation of TOC in businesses around the globe has achieved tremendous improvements in profitability by maintaining the focus of management attention on the goal of the business: to make more money now and in the future. TOC is based on the core assumption that the profitability and success of a business is primarily controlled by one leverage point or System Constraint (TOC term).

The specific solution developed for project management by Dr. Goldratt, and his trained TOC implemented, is Critical Chain Project Management (CCPM). This superior method of managing projects has led to large improvements in reducing project lead time and resource consumption. Many companies around the world have implemented CCPM with very good results. The CCPM method identifies a critical chain of tasks within the project on which management attention focuses. Time Buffers (labeled Safety Buggers in TOC applications) are strategically placed within the chain and at the end of the chain to manage the variation that causes (in traditional project management applications) delays, conflicts, and financial loss. The CCPM method is based on the underlying assumption that the company/organization executing a project has control of the project schedule. This assumption is not valid in some industries and specifically in the construction industry—a very large industry that has suffered from low and declining resource utilization and productivity for more than fifty years.

This new project management system has been developed to utilize the principles imbedded within CCPM while addressing the invalidated assumption of “control of schedule”. The system provides a simple and practical solution for project management in industries where the company or organization does not have control over their schedule—the schedule being dictated to them by another controlling party (such as a general contractor to their trade contractors). This system may allow users to define and setup projects, and then to execute them on a daily, weekly, and monthly basis in a way to significantly increase resource productivity. This increase in productivity is pivotal in completing projects on time and within budget and multiplying profitability. In essence, this system establishes a user experience that implements continuous improvement in productivity and profitability for a portfolio of projects (one to thousands). The construction industry is headed into a crisis situation with its inherent low productivity and shrinking workforce. This system enables project managers to utilize workers in a way that substantially increases productivity, expands the capacity of a given workforce, and completes projects at a greater rate. The following description of the system addresses at least increasing productivity while simultaneously expanding the capacity of the workforce.

### SUMMARY

A system and method for increasing project productivity in project management, the system may comprise a processor programmed with predetermined logic sequences for measuring the throughput opportunity for a task and/or a project. The processor may be configured to receive a first input signal of the project and/or the task with an initial set of values. The processor processes the initial set of values against logic sequences pre-programmed into the processor. The processor produces an initial output utilizing the first set of values showing a clear path of the project or the tasks or both. The clear path is utilized to determine resources required to complete tasks within the project as well as the projects themselves. The processor also receives at least one second input signal with a second set of values. The processor processes the second set of values. The processor produces a second output utilizing the first set of values and the second set of values to provide an updated value of what is remaining on the task and/or the project. The system further includes a user interface for a user to access the clear path and updated clear path values or throughput opportunity.

The initial set of values may comprise the quantity of clear path man days to complete the project, or the tasks, or both, the project dollar amount, and the project value.

The processor may further be configured to signal a memory unit within the processor to process the initial set of values through at least one first formula to produce the first output. The first output may comprise a total opportunity value of the project, a total capacity value of the current staffing, and a throughput value being produced by the current capacity value.

The second set of values may comprise man days worked at an interval of time, remaining man days at the interval of time, and/or man days used for rework.

The processor may be further configured to signal a memory unit within the processor to process the second set of values through at least one second formula to produce the second output, the second output may comprise a throughput value of the project, a productivity value of the project, a throughput capacity value of the project, a throughput opportunity value of the project, the total cost of rework, and/or the project safety (time buffers) remaining.

### BRIEF DESCRIPTION OF THE FIGURES

FIG. 1 schematically illustrates a system with a processor, logic unit, and memory, according to the present disclosure.

FIG. 2 illustrates a legend for the flowcharts of FIGS. 3-6.

FIG. 3 illustrates a flowchart of inputs and outputs for the system of FIG. 1.

FIG. 4 illustrates a flowchart of an example Resource Planning Module.

FIG. 5 illustrates a flowchart of an example Weekly Planning Module.

FIG. 6 illustrates a flowchart of an example Safety Computation.

FIG. 7 illustrates one example of creating and/or editing a change order for a project.

FIG. 8 illustrates one example of creating and/or editing a project contract amount.

FIG. 9 illustrates one example of creating and/or editing tasks for a project.

FIG. 10 illustrates example inputs for determining project safety.

FIG. 11 illustrates one example of setting a week, such as for a weekly plan.

FIG. 12 illustrates one example for inputting remaining ManDays.

FIG. 13 illustrates one example of an updated Throughput Opportunity.

FIG. 14 illustrates one example of inputting or updating ManDays for reworks.

FIG. 15A illustrates one example of a graph of productivity by week and FIG. 15B illustrates one example of a graph of throughput by week.

FIG. 16A illustrates one example of a chart of Throughput Opportunity by week.

FIG. 16B illustrates one example of a chart of Weekly Staffing.

FIG. 16C illustrates one example of a chart of Project Completion by week.

FIG. 16D illustrates one example of a chart of Through Capacity by week.

FIG. 17A illustrates one example of a chart of Safety Consumed versus Project Completion.

FIG. 17B illustrates one example of a chart of Poor Quality Costs resulting from rework.

FIG. 18 illustrates one example of company totals for Throughput and Opportunity.

FIG. 19 illustrates one example of a project summary of outputs.

FIG. 20 illustrates one example of contract and change order outputs.

FIG. 21 illustrates one example of an interface for building a Weekly Plan.

FIG. 22 illustrates examples of various inputs that may be required to create a resource.

FIG. 23 illustrates one example of an interface to build a Weekly Resource Plan.

FIG. 24 illustrates one example of a Staffing report.

FIG. 25 illustrates one example of an interface for building a Project Completion Profile.

FIG. 26 illustrates one example of a report detaining projected revenue and Throughput for a company.

### DETAILED DESCRIPTION

The following description sets forth a system and its use as a project management tool to increase productivity and accountability. While one embodiment may have benefit within the construction management industry, the system may be utilized in a plurality of industries. Project management-based industries, and specifically the construction industry, utilize many terms that may not be readily apparent. Those terms are defined herein. Theory of Constraints (TOC) will be referred to often as the paradigm that the desired output of any manageable system is controlled by a limited number of constraints. Throughput, with regard to TOC, is the rate at which a business system makes money. In this system, “Throughput” means the rate at which project value is being created. ManDays is the estimated duration of a task to be completed in day increments. Productivity is the amount of Throughput created divided by the ManDays that created it. ClearPath ManDays means the number of ManDays available to complete a task before running into an obstacle. ClearPath Productivity means the amount of Throughput Margin divided by the ClearPath ManDays. Remaining Throughput Margin is the amount of Throughput Margin still remaining to complete a task or a project. Throughput Capacity is the amount of staff capacity multiplied by the ClearPath Productivity. Throughput Opportunity means the number of ManDays of work available to produce without any obstacle(s), and the Throughput Opportunity measured in dollars is the number of ManDays multiplied by the ClearPath Productivity value. Other terms will be utilized herein and provided definitions throughout the disclosure.

The definitions above and others are provided for ease in review of the following table. Some, or all of these, terms may be utilized in the detailed description of the figures, images, drawings, tables, or claims. The terms are intended to be inclusive and not as a limitation in understanding the system.

TABLE 1

| Term usage | Term Definition |
|---|---|
| Throughput | The rate at which the business system makes money |
| (TOC community) | |
| Throughput (software) | The rate at which project value is being created |
| Remaining Throughput | The amount of Throughput Margin still remaining to produce on a |
| Margin | project |
| Project Completion | The percentage of Throughput Margin remaining to be completed on a |
| | project |
| Throughput Capacity | Amount of Staff Capacity multiplied by ClearPath Productivity |
| Throughput | Number of ManDays ™ of work available to produce without any |
| Opportunity ™ | obstacle |
| Throughput | Throughput Opportunity ™ measured in dollars (ManDays ™ * |
| Opportunity ™ ($) | ClearPath P-Target ™) |
| Productivity | The Ratio of Throughput generated by a system divided by the |
| (TOC Community) | Operating Expense to generate it |
| Productivity | Amount of Throughput created divided by the ManDays ™ that created |
| | it |
| ClearPath Productivity | Amount of Throughput Margin divided by ClearPath ManDays ™ |
| Productivity with Safety | Amount of Throughput Margin divided by ManDays ™ with Safety |
| 5-Week Productivity | Productivity from past five weeks summed and divided by 5 |
| Average | |
| ManDays ™ | Estimated duration of a task to be completed in day increments |
| ClearPath ManDays ™ | Number of ManDays ™ available to complete on a task before running |
| | into any obstacle |
| Original ManDays ™ | Number of ManDays ™ estimated to complete an entire task/project |
| Update ManDays ™ | Updating the number of ManDays ™ on a task remaining to be |
| | completed |
| Remaining ManDays ™ | Number of ManDays ™ on a task remaining to be completed on a given |
| | date |
| T-Opp ™ in ManDays ™ | Number of ManDays ™ available to be completed on Tasks on a given |
| | date |
| Expected ManDays ™ | Number of ManDays ™ expected to be completed on Tasks for a given |
| | week |
| Project Safety | Number of total ManDays ™ on a project as an allowance for delays |
| | (Murphy) |
| Safety per task Element | Number of ManDays ™ added as Safety to the amount of ClearPath |
| | ManDays ™ |
| ManDays ™ with Safety | Number of ManDays ™ for a project Element with Safety added to the |
| | total |
| Safety Consumption | Amount of Safety used divided by the Project Safety for a given date |
| | range |
| Safety Account | Total ManDays ™ of Safety allocated for Project multiplied by the |
| | ClearPath P-Target ™ |
| Project Risk | Percentage of Safety Account used compared to the percentage of |
| | Project completed |
| Unscheduled Tasks | Any/all tasks on the project that currently have Throughput |
| | Opportunity |
| Scheduled Tasks | The Unscheduled tasks that are now selected for the week's work plan |
| Active Staff | Number of workers available to work on a Project in a given week |
| Inactive Staff | The names of workers who are not available on a Project for a given |
| | week |
| Weekly Staffing | The assignment of workers to specific tasks to make up the Weekly |
| | Plan |
| Planned ManDays ™ | The total number of ManDays ™ expected to be worked for the given |
| | week |
| Availability for active | The expected days Available to work designated for each of the Active |
| staff | Staff |
| T-Opp ™ per active staff | Total ManDays ™ planned for individual workers by task and by week |
| Contract Amount | Total Revenue expected to be earned on a Project (to be paid by client) |
| Totally Variable Costs | Cost of materials, subcontractors and 3rd party services (wages not |
| (TVC) | included) |
| Throughput Margin | Contract Amount minus Totally Variable costs |
| Change Orders | Extra worked performed on a Project that client agrees to pay for |
| Task Value | The product of ClearPath ManDays ™ on a Task multiplied by the |
| | ClearPath P-Target ™ |
| Poor Quality Costs | The number of ManDays ™ used for Rework multiplied by the |
| | ClearPath P-Target ™ |
| Multi-tasking metric | The numbers of weeks a Task is open divided by 5 |
| PM Rating | The project Productivity divided by the ClearPath P-Target ™ |
| | multiplied by a constant |
| Project Completion | A projected distribution of completion percentages as defined by the |
| Profile | sum of the Project Completion %'s per time period (sums to 100%) |
| Project Completion % | The fraction (measured in %) of the project that is projected to be |
| per Time Period | completed for a given time period |
| Projected Revenue per | The portion (measured in $) of a project's Revenue that is projected to |
| Time Period | be completed within a given time period (dollars multiplied by %'s) |
| Projected Throughput per | The portion (measured in $) of a project's Throughput that is projected |
| Time Period | to be completed within a given time period (dollars multiplied by %'s) |
| Resource | A person (or tool or equipment) that is used to complete work on a task |
| Region | A geographic area defined in which a company's projects are |
| | performed |
| Trade | A specific trade within an industry that a company does work in |
| Staff | A list of human Resources used to perform work within a project, trade |
| | or region |
| Available ManDays ™ | Number of days a human Resource is available to work in a given time |
| per Resource | period |
| Staff ManDays ™ | The sum of Available ManDays ™ per Resource assigned to a project |
| | for a time period |
| Weeks of Available | Calculation of Opportunity, dividing T-Opp ™ in ManDays ™ by Staff |
| opportunity for Work | ManDays ™ |
| Project Staffing Status | A comparison of Weeks Available to a “best staffing” metric of T- |
| | Opp ™ |

In this description, some drawings may illustrate signals as a single signal for clarity of presentation and description. It will be understood by a person of ordinary skill in the art that the signal may represent a bus of signals, wherein the bus may have a variety of bit widths and the present description may be implemented on any number of data signals including a single data signal. The system may communicate over the internet, ethernet, and/or through a variety of wired or wireless connections. The servers may include multiple databases and information centers depending on the amount of data collected and produced. The system may also communicate with a single worker, supervisor, manager, contractor, clients and/or customers.

The system may be maintained on a platform that is either on the cloud, or physically housed in a separate location, or at the location of a customer or client. The system may provide notifications to the user, staff, supervisor, manager, customer, contractor, or client (i.e., “user”). A notification may be provided to a user when new data is processed through the system after a weekly update providing updated values in the system. A user interface is utilized to provide inputs and receive outputs into the system. The user interface may be any computer readable medium including a computer, a tablet, a laptop, a phone or the like.

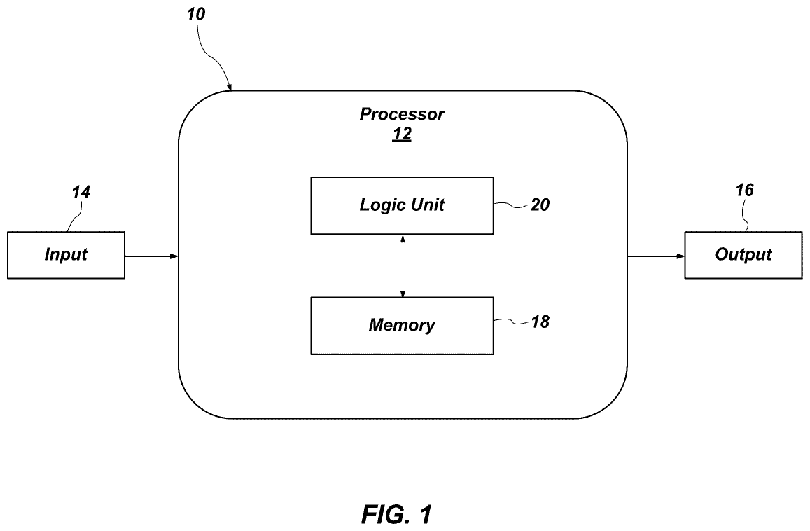

FIG. 1 provides a simplistic understanding of a system 10 which includes a processor 12 that receives an input 14 and provides an output 16.

The input may be a user generated input of a new project with specific project parameters including budget, task definition and durations, staff or resources, and other project values. Other inputs may be system generated or from other third-party sources other than the initial user inputs. The processor 12 may include a memory 18 that maintains preprogrammed functions and information that may be utilized by the logic unit 20, these preprogrammed functions may be utilized to further populate and be stored in the memory 18. The memory 18 may include commands that, when processed through the logic unit 20, then produce the first output 16 which may be a report of current project status and potential project opportunities based on status. The processor 12 may provide multiple outputs depending on the status of the logic unit 20. Depending on the inputs 14, the processor 12 may require additional inputs loaded by a user to accurately provide the desired outputs 16.

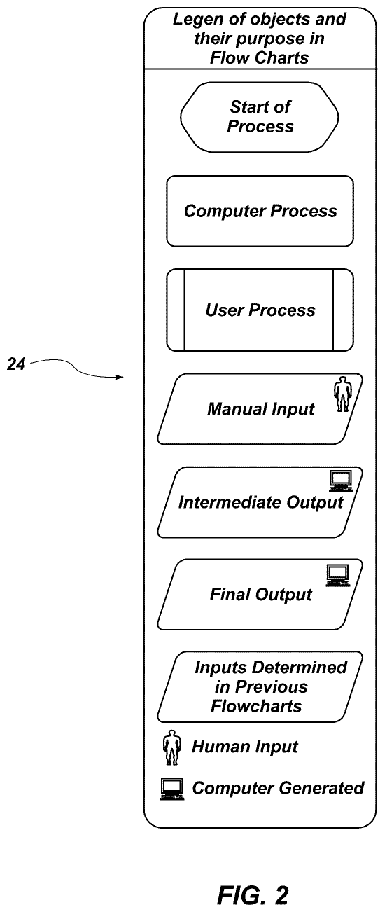

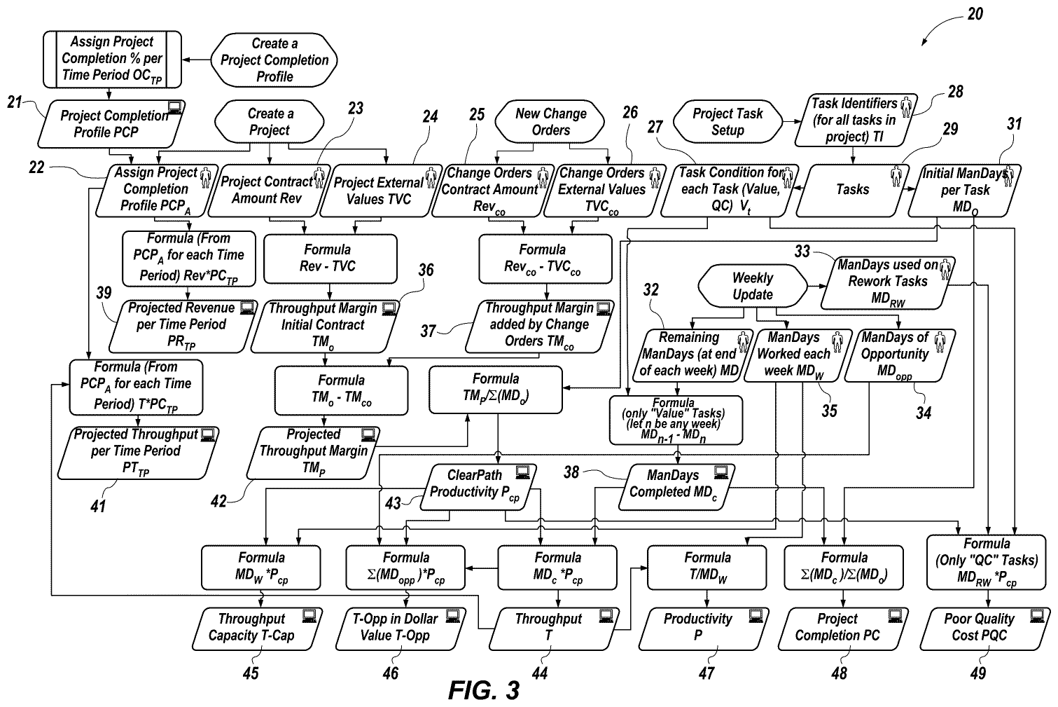

FIG. 3 shows a plurality of the inputs and outputs 20 along with the memory 18 and logic unit 20 sequences of the foundation system 10. A legend 24 is provided in FIG. 2 to adequately review the flowchart 20 to distinguish between inputs, outputs, processer functions, user functions, and user/manual inputs. FIG. 3 may be referred to as the Foundation of Program.

Each of the values of FIG. 3 are identified in the following table and provide ease in reviewing the input, output, and process of each box.

TABLE 2

| Inputs (uniquely defined by user) | Label | Process | FIG. # |
|---|---|---|---|
| Assign Project Completion Profile (22) | PCP_{A} | Initial Project Setup | 7 |
| Project Contract Amount (23) | Rev | Initial Project Setup | 7 |
| Project External Values (24) | TVC | Initial Project Setup | 7 |
| Change Orders Contract Amount (25) | Rev_{co} | Change Order Setup | 8 |
| Change Order External Values (26) | TVC_{co} | Change Order Setup | 8 |
| Task Condition for each Task (27) | Vₜ | Project Task Setup | 9 |
| Task Identifiers (28) | TI | Project Task Setup | 9 |
| Tasks (29) | Tasks | Project Task Setup | 9 |
| Initial ManDays per Task (31) | MDₒ | Weekly Update | 12, 20 |
| Remaining ManDays (32) | MD | Weekly Update | 12 |
| ManDays used on Rework Tasks (33) | MD_{RW} | Weekly Update | 14 |
| ManDays of Opportunity (34) | MD_{Opp} | Weekly Update | 13, 23 |
| ManDays Worked each week (35) | MD_{w} | Weekly Update | 11, 16B, 18 |
| | Label | Formula/Query | FIG. # |
| Outputs (intermediate) | | | |
| Throughput Margin Initial Contract (36) | TMₒ | Rev − TVC | 18, 20 |
| Throughput Margin added by Change | TM_{co} | Rev_{co} − TVC_{co} | 18 |
| Orders (37) | | | |
| ManDays Completed (38) | MD_{c} | MDₙ₋₁ − MDₙ | 12 |
| Outputs (illustrated for users) | | | |
| Project Completion Profile (21) | PCP | Group(PC_{TP}) | 8 |
| Projected Revenue per Time Period (39) | PR_{TP} | Rev*PC_{TP} | 8 |
| Projected Throughput per Time | PT_{TP} | T*PC_{TP} | 8 |
| Period (41) | | | |
| Project Throughput Margin (42) | TMₚ | TMₒ − TM_{co} | 19, 20 |
| ClearPath Productivity (43) | P_{cp} | TMₚ/Σ(MDₒ) | 18, 19, 20 |
| Throughput (44) | T | MD_{c}*P_{cp} | 15B, 18 |
| Throughput Capacity (45) | T-Cap | MD_{w}*P_{cp} | 16B |
| Throughput Opportunity (46) | T-Opp | Σ(MD_{Opp})*P_{cp} | 16A, 18, 19 |
| Productivity (47) | P_{cp} | T/MD_{w} | 18, 19, 20 |
| Project Completion (48) | PC | Σ(MD_{c})/Σ(MDₒ) | 16C, 17A, 19 |
| Poor Quality Cost (49) | PQC | MD_{RW}*P_{cp} | 17B, 18 |

A primary input may be the creation of the project 51 in the system by inputting the project values 24 and total contract amount 23 or value. The system, or a user, then processes those inputs to provide initial outputs including the Initial Throughput Margin 36.
TMₒ−TM_{co} wherein the TMₚ is derived by TMₒ−TM_{co} wherein TMₒ is derived from Rev−TVC and the TM_{co} is derived from Rev_{co}—TVC_{co}

Further processes are performed as outlined in Table 2 wherein the functions, equations, and algorithms are set forth, and a Project Throughput Margin 42 is provided. A user may access this information; however, the system may further process that information to identify and process additional inputs including change orders, delays, updates to the project or tasks, task values, or any of a plethora of additional inputs. These updates may then be fed through the processor to provide the ClearPath Productivity 43 by the Project Throughput Margin 42 divided by the sum of the initial ManDays 31 per task.

TMₚ/Σ(MDₒ)

The processor is able to identify the Throughput Capacity 45 by the ManDays worked (input) 35 multiplied by the Productivity 47.

MD_{w}*P_{cp}

Wherein the Productivity 47 is derived from the Throughput 44 divided by the ManDays worked 35.

T/MD_{w}

The Throughput T is derived from the ManDays completed 38 multiplied by the Productivity 47.

MD_{c}*P_{cp}

The processor is also able to identify the Throughput Opportunity 46 which is the sum of the ManDays of Opportunity 34 multiplied by the Productivity 47.

Σ(MD_{Opp})*P_{cp}

The user is able to access this output of the Throughput Capacity 45 or Throughput Opportunity 46 through the user interface.

In some embodiments, the first output 16 (referring back to FIG. 1) may include a project completion profile. The project completion profile may include various forecasts for a project. For example, the project completion profile may forecast: Projected Revenue by time period (Month, quarter, year) for a project; Projected Throughput by time period (month, quarter, year) for a project; and/or, through combining all projects, create a forecast of projected Revenue and Throughput for a company. Project completion profiles may be set up by a company at any time and even during or at the set-up of a customer. The system 10 may preprogrammed with the logic unit 20 and memory 18 when provided to a user or it may be programmed when at initial setup with specific actions, algorithms, sequences, functions that are specific to a user. Additionally, the system may be continually programmed, reprogrammed, and/or updated by a user during its real-time use.

The secondary inputs, after the initial inputs of projects and tasks into the system, may require a user to input and/or update the number of ManDays 35 into the system. These updates in the system can occur at any interval such as daily, weekly, or monthly, or any other common interval for the tasks or projects. For example, after a first set of tasks is input into the processor a specific output is realized. After one week, an update to the system may occur and an update to the ManDays 35 in the system may be provided as an input into the processor. The input may be the number of ManDays remaining 32 on a task or the number of ManDays worked 35. Additionally, another input may be a number of ManDays where there is opportunity 34. The processor then utilizes the information provided and the functions stored in the memory of the logic unit which then provides an output. Specifically, with inputting the number of ManDays remaining 32, the system is able to identify the number of ManDays completed 38. Further, the system provides outputs that may include the Throughput 44, the Productivity 47, as set forth previously herein, based on the previous weeks' inputs. Additionally, the system may provide outputs of the Project Completion 48 based on the previous weeks' inputs, which is the sum of the ManDays completed 38 divided by the sum of the initial ManDays per task 31.

Σ(MD_{c})/Σ(MDₒ)

The system may also provide outputs of the Poor Quality Cost 49 based on the previous weeks' inputs, which is the number of ManDays 33 used on rework tasks multiplied by the Productivity 47.

MD_{RW}*P_{cp}

With the weekly updated inputs of ManDays worked 35 and ManDays of Opportunity 34, the system is able to take those inputs along with the functions in the memory and, through the logic unit, provide the updated outputs of Throughput Capacity 45, Throughput achieved 44, and Throughput Opportunity 46. These outputs provide a user with the feedback to be able to adjust staff and increase or decrease the staff, thus increasing or decreasing ManDays of capacity, to achieve the greatest Productivity 47 according to the system output.

The system may also be utilized in identifying poor quality costs and identifying quality risks from the input of ManDays of rework 33.

Each of the values of the preceding image for Resource Planning 30 are identified in the following Table 3 and provide ease in reviewing the input, output, and process of each box. As a non-limiting example relating to the construction industry, a computational process resulting in a calculated time period of four (4) weeks is the “sweet spot,” where the project is optimally staffed for productivity and efficiency.

TABLE 3

| Inputs (uniquely defined by user) | Label | Process | FIG. # |
|---|---|---|---|
| Resource Details (51) | R | Create Resource | 22, 23 |
| Set Available ManDays per Resource (52) | AMD_{Staff} | Initial Project Setup | 23 |
| | Label | Formula/Query | FIG. # |
| Outputs (intermediate) | | | |
| Staff ManDays (53) | MD_{Staff} | Σ(AMD_{Staff}) | 23 |
| Outputs (illustrated for users) | | | |
| Weeks of Available Opportunity for | Weeks | MD_{Opp}/MD_{Staff} | 23 |
| Work (54) | | | |
| Project Staffing Status (55) | PSS | 1 < Weeks < 7 | 23, 24 |
| | | Overstaffed to Understaffed | |
| Compare all Project's Staffing Status (56) | | Query all Projects by Filter | 23, 24 |

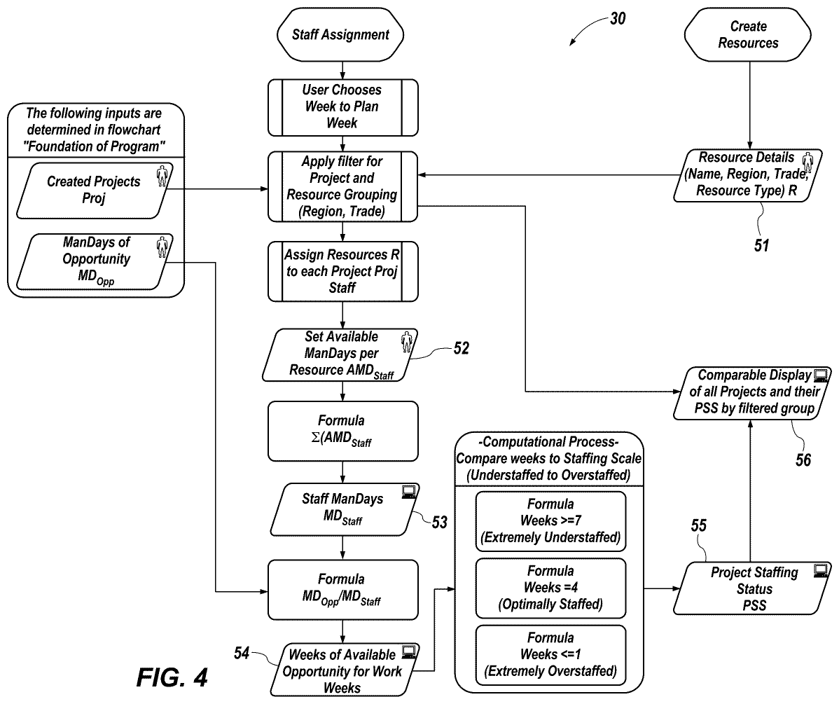

Referring to FIG. 4, Resource Planning is implemented into the system. Through the system, a resource plan is put in place for resources, defined further herein, that may be utilized to complete the projects, or tasks, or both. The implementation is thus the allocating or reallocating resources based on the change in Throughput Opportunity.

FIG. 4 illustrates a flowchart of an example Resource Planning module or process 30. In some embodiments, the Resource Planning process 30 is set up by a company and is inclusive of the company's resources that perform the work to complete tasks and/or projects. The Resource Planning module or process 30 may create resources 51 (e.g., representing field workers) within the processor, logic unit, and/or memory unit. Additionally, and/or alternatively, the Resource Planning process 30 may create a type of resource 51, including capabilities and/or a skill level. The Resource Planning process 30 may also manage a resource pool rather than a single project (e.g., a group of projects) and create visibility into the resource pool (e.g., by updating the resource planning by week, day, month, etc.). Additionally, and/or alternatively, a user may manually update the Resource Planning module or process 30.

The Resource Planning process 30 also allows for resources to be assigned to project(s), which creates “Staff” 52 for the project(s). Resource Planning 30 may also specify the ManDays available for each resource assigned to the project and may produce the number of “Weeks” 54 available for work on the project from available ManDays of Opportunity and from the ManDays available from the Staff, or Staff ManDays 53.

MD_{Opp}/MD_{Staff}

In some embodiments, based on the produced number of Weeks, Resource Planning 30 may produce the Project Staffing Status 55 for the project(s). Additionally, and/or alternatively, Resource Planning 30 may facilitate display of all projects 56 and staff together to manage a resource pool across the company, which allows for proper staffing of projects according to the opportunity of work on the projects a company is working on concurrently.

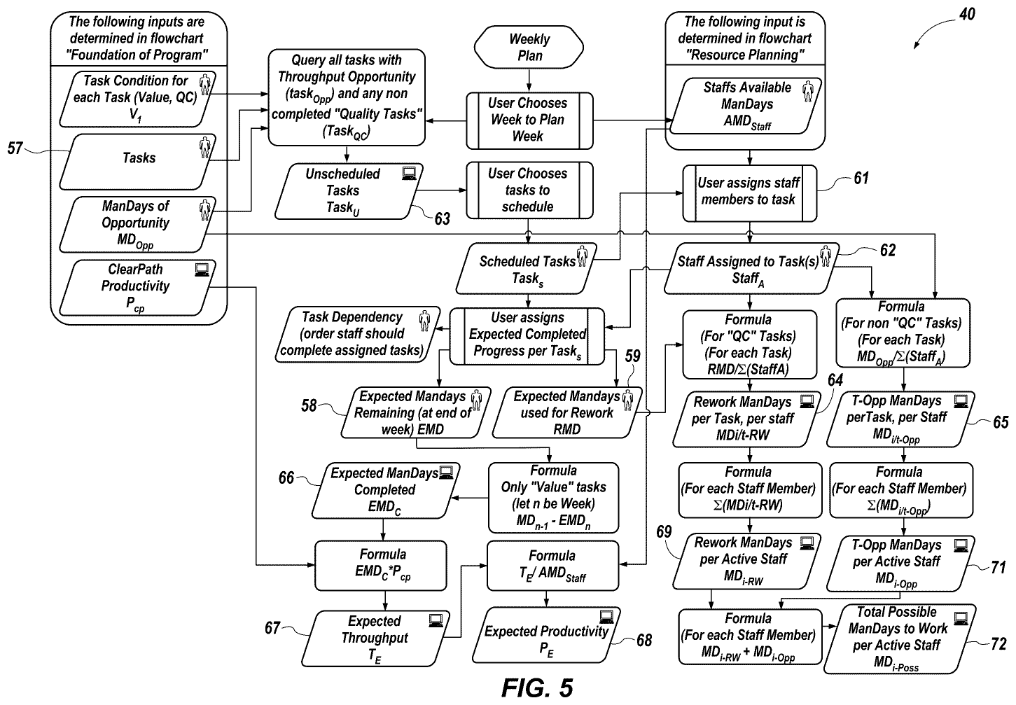

FIG. 5 illustrates a flowchart of an example Weekly Planning Module 40, the values of which are identified in the following Table 4 and provide ease in reviewing the input, output, and process of each box. Through the system, a weekly plan is put in place for tasks to be completed and corresponding staff assignments. The following image showcases the weekly planning process that utilizes some of the inputs set forth in the previous flowchart

TABLE 4

| Inputs (uniquely defined by user) | Label | Process | FIG. # |
|---|---|---|---|
| Scheduled Tasks (57) | Tasks | Weekly Planning | 21 |
| Task Dependency | | Weekly Planning | 21 |
| Expected ManDays Remaining (58) | EMD | Weekly Planning | 21 |
| Expected ManDays used for Rework (59) | RMD | Weekly Planning | 21 |
| Staff's Available ManDays (61) | AMD_{Staff} | Weekly Planning | 21 |
| Staff Assigned to Task(s) (62) | Staff_{A} | Weekly Planning | 21 |
| | Label | Formula/Query | FIG. # |
| Outputs (intermediate) | | | |
| Unscheduled Tasks (63) | Task_{U} | Task_{Opp} + Task_{QC} | 21 |
| Rework ManDays per Active Staff (64) | MD_{i-RW} | Σ(MD_{i/t-RW}) | |
| T-Opp ManDays per Active Staff (65) | MD_{i-Opp} | Σ(MD_{i/t-Opp}) | |
| Outputs (illustrated for users) | | | |
| Expected ManDays Completed (66) | EMD_{c} | MDₙ₋₁ − EMDₙ | 12, 21 |
| Expected Throughput (67) | T_{E} | EMD_{c}*P_{cp} | 21 |
| Expected Productivity (68) | P_{E} | T_{E}/AMD_{Staff} | 21 |
| Rework ManDays per Task, per Staff (69) | MD_{i/t-RW} | RMD/Σ(Staff_{A}) | 21 |
| T-Opp ManDays per Task, per Staff (71) | MD_{i/t-Opp} | MD_{Opp}/Σ(Staff_{A}) | 21 |
| Total Possible ManDays to Work per Active | MD_{i-Poss} | MD_{i-RW} + MD_{i-Opp} | 21 |
| Staff (72) | | | |

The planning tool 40, which may be weekly, may utilize the outputs of the initial project setup, or previous weeks from the previous flowchart, and as set forth above (i.e., Throughput Opportunity 46, ManDays of Opportunity 34, Tasks 57, and ClearPath Productivity 43). With these outputs the system may require manual inputs of upcoming tasks, which may be scheduled weekly. With the previous outputs of tasks, an additional initial output of expected ManDays completed 66 may be provided as an output by the system after the weekly update of tasks. The processor may then further analyze the value of those expected ManDays remaining 58 to those Tasks 57 and provide a further output on the expected ManDays to Completion 66, which will further provide the outputs of expected Throughput 44 and expected Productivity 47.

Additionally, the processor may include, within the memory, the staff as defined in the Resource Planning module 30. Not only the staff name but the availability of staff members. wherein such availability may be showcased in days, hours, weeks, or months, or any other time frame. A user may assign staff 61 to a specific task or project in the system. The system, through the weekly update (input) of ManDays (worked or left to complete) is able to produce the ManDays of Opportunity per staff member 65 as an output by takin the ManDays of Opportunity 34 and dividing by the sum of the Staff 62

MD_{Opp}/Σ(Staff_{A})

It will be appreciated that rework of tasks and projects can be calculated through the system and accounted for in the weekly updates. While weekly updates are used as the example, it will be appreciated that updates can occur at any time interval including days, weeks, months, and years.

The system may utilize buffers for performance variation in completion of tasks to provide a reasonable target for project Productivity. This buffer is identified in the system as Safety (time buffers). The following image showcases the system's ability to establish Safety within a project as a specific project management strategy.

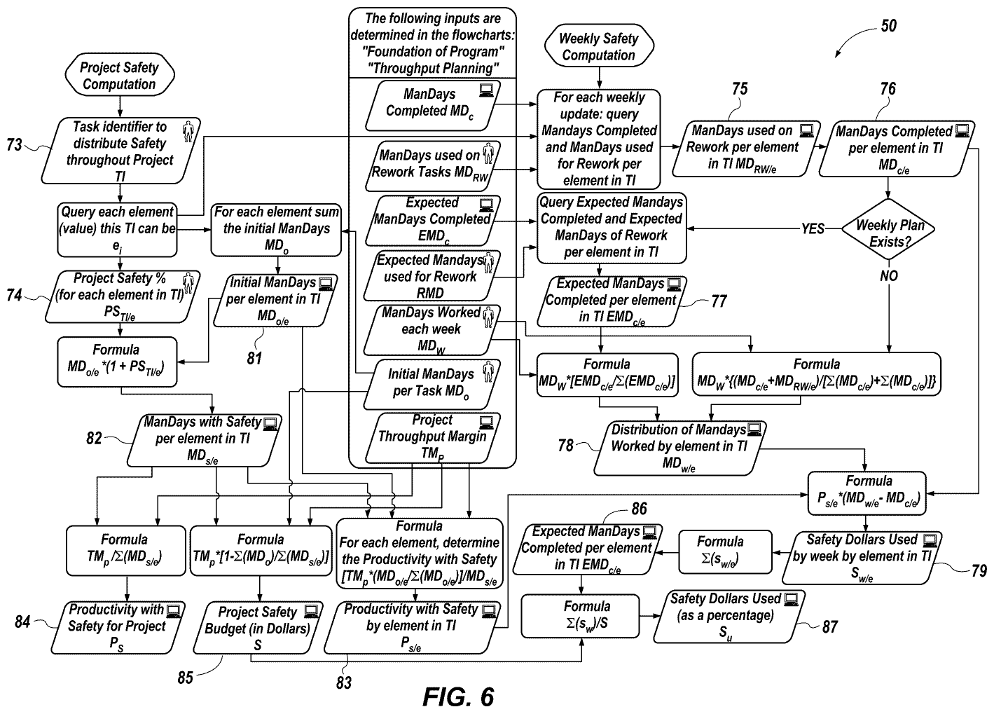

FIG. 6 illustrates a flowchart of an example Safety (time buffers) Computation 50, the values of which are identified in the following Table 5 and provide ease in reviewing the input, output, and process of each box.

TABLE 5

| Inputs (uniquely defined by user) | Label | Process | FIG. # |
|---|---|---|---|
| Task Identifier to distribute Safety | TI | Project Task Setup | 10, 20 |
| (73) | | | |
| Project Safety (%) (74) | PS_{TI/e} | Project Task Setup | 10, 20 |
| Outputs (intermediate) | Label | Formula/Query | FIG. # |
| ManDays used on Rework per | MD_{RW/e} | Query | |
| element in TI (75) | | | |
| ManDays Completed per Element | MD_{c/e} | Query | |
| in TI (76) | | | |
| Expected ManDays Completed per | EMD_{c/e} | Query | |
| element in TI (77) | | | |
| Distribution of ManDays Worked | MD_{w/e} | MD_{w}*[EMD_{c/e}/Σ(EMD_{c/e})] or | |
| by element in TI (78) | | MD_{w}*{(MD_{c/e} + MD_{RW/e})/[Σ(MD_{c/e}) + Σ(MD_{RW/e})]} | |
| Safety Dollars used by week by | Sw/e | P_{s/e}*(MD_{w/e} − MD_{c/e}) | |
| element in TI (79) | | | |
| Outputs (illustrated for users) | S_{w/e} | Formula/Query | FIG. # |
| Initial ManDays per element in TI | Label | Query | 10, 20 |
| (81) | | | |
| ManDays with Safety per element | MD_{o/e} | MD_{o/e}*(1 + PS_{TI/e}) | 10, 20 |
| in TI (82) | | | |
| Productivity with Safety by element | MD_{s/e} | [TMₚ*(MD_{o/e}/Σ(MD_{o/e})]/MD_{s/e} | 20 |
| in TI (83) | | | |
| Productivity with Safety for Project | P_{s/e} | TMₚ/Σ(MD_{s/e}) | 20 |
| (84) | | | |
| Project Safety Budget (85) | Pₛ | TMₚ*[1 − Σ(MD_{o/e})/Σ(MD_{s/e})] | 19 |
| Safety Dollars Used by week (86) | S | Σ(S_{w/e}) | 19 |
| Safety Dollars Used by percentage | S_{w} | Σ(S_{w/e})/S | 17A, 18 |
| (87) | | | |

With all of the inputs, processes, and outputs of the system previously disclosed additional information can be gathered by a few simple inputs into the system. Safety is input into the system with the setup of the project, or group of tasks or both. Many of the inputs for task status correlate with the outputs of the foundation system 20 and the weekly planning 40. Safety consumption is thus computed based on the inputs of the weekly planning. With a few additional inputs that establish Safety parameters and the outputs from the foundation system and weekly planning system stored in the memory, along with the functions stored in the memory, the logic unit produces further outputs of Safety used. The final safety outputs are presented in a project safety account that displays the safety budget in dollars along with weekly usage or deposits in that account.

A task identifier is identified to distribute Safety (time buffers) throughout the project 73. Project Safety percentages 74 are assigned for each task identifier 73. Utilizing the initial ManDays per Task 31 and utilizing the initial ManDays per element 81 the ManDays of Safety per element 82 may be obtained by multiplying both those elements by one plus the Project Safety percentage 74.

MD_{o/e}*(1+PS_{TI/e})

Productivity with Safety 84 may then be established by dividing the Project Throughput Margin 42 by the Sum of the ManDays of Safety per Element 82.

TMₚ/Σ(MD_{s/e})

The Project Safety Budget 85 is derived by one minus the sum of the initial ManDays 31 divided by the sum of the ManDays with safety per element 82, all multiplied by the Project Throughput Margin 42.

TMₚ*[1−Σ(MD_{o/e})/Σ(MD_{s/e})]

Productivity with safety by element 83 is derived by the Initial ManDays per element 81 divided by the sum of the total Initial ManDays per element 81, all multiplied by the Project Throughput Margin 42, then divided by the ManDays with Safety per element 82.

[TMₚ*(MD_{o/e}/Σ(MD_{o/e})]/MD_{s/e}

The Distribution of ManDays worked by element 78 may be derived by the Expected ManDays completed per element 77 divided by the sum of all the Expected ManDays completed per element 77, multiplied by the ManDays Worked 35.

MD_{w}*[EMD_{c/e}/Σ(EMD_{c/e})]

An alternate to determining the Distribution of ManDays worked by element 78 is the sum of ManDays Completed per element 76 is added to the ManDays used on rework per element, then divided by the sum of the total ManDays Completed per element 76 added to the total ManDays used on rework per element and then multiplied by the number of ManDays Worked 35.

MD_{w}*{(MD_{c/e}+MD_{RW/e})/[Σ(MD_{c/e})+Σ(MD_{RW/e})]}

To determine the Safety Dollars by week by element 79 take Distribution of ManDays 78 minus the ManDays complete per element 76 multiplied by the Productivity with Safety by element 83.

P_{s/e}*(MD_{w/e}−MD_{c/e})

The Safety Dollars Used by week 86 is derived by the sum of the Safety Dollars used by week by element 79.

Σ(S_{w/e})

The Safety Dollars Used by percentage 87 can then bed derived by simply dividing the sum of the Safety Dollars used by week 86 by the Project Safety Budget 85.

Σ(S_{w/e})/S

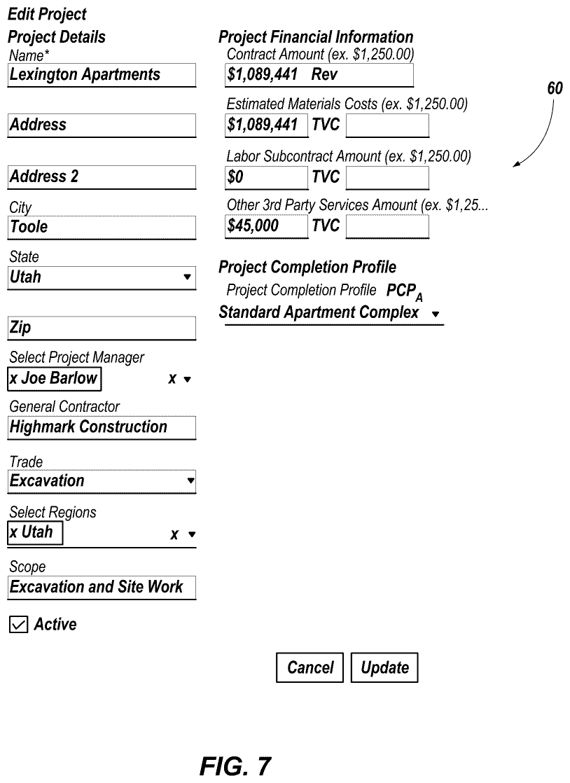

FIGS. 7-26 showcase what the system may provide as an interactive tool for the user. The labels provided herein also correspond to those provided in the tables above. While these images show an example of how the data may be input and corresponding outputs which may be provided, it will be appreciated that any number of methods may be used to input or display that data described herein.

FIG. 7 illustrates one example of creating and/or editing a change order 60 for a project.

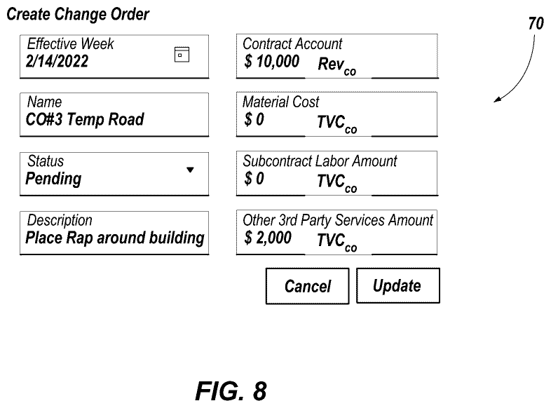

FIG. 8 illustrates one example of creating and/or editing a project contract amount 70.

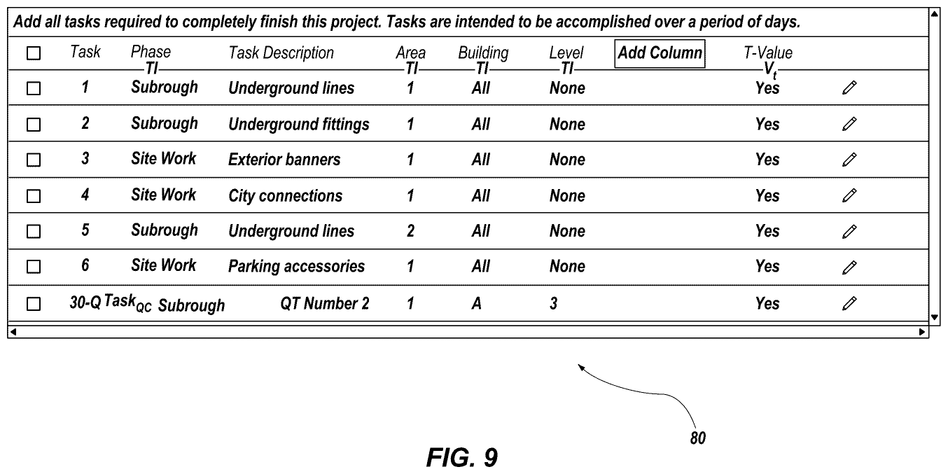

FIG. 9 illustrates one example of creating and/or editing tasks for a project 80.

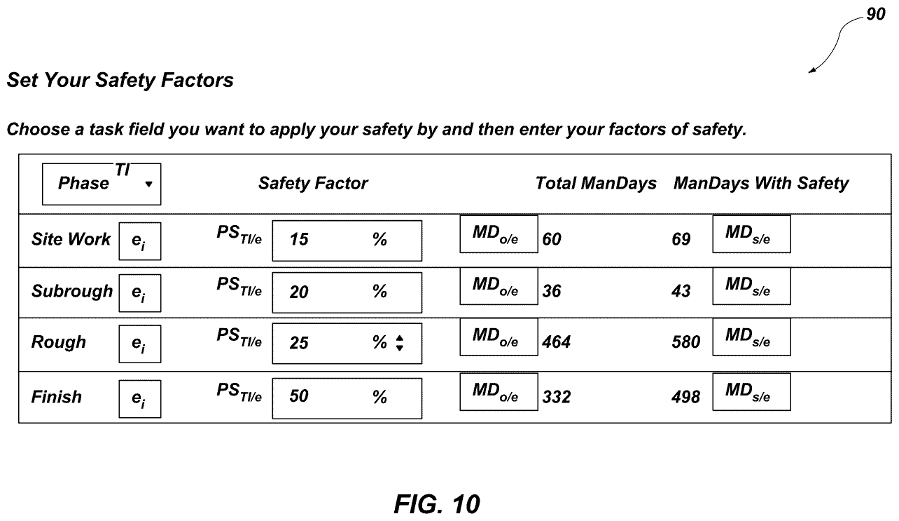

FIG. 10 illustrates example inputs for determining project safety 90.

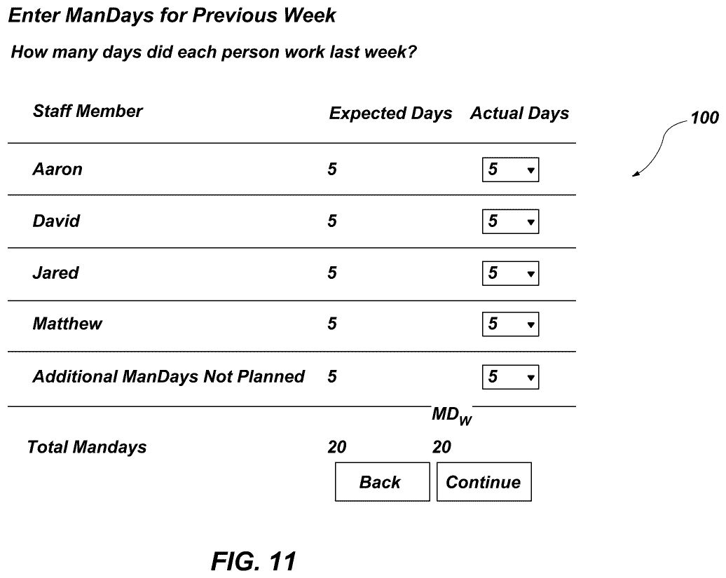

FIG. 11 illustrates one example of setting a week, such as for a weekly plan 100.

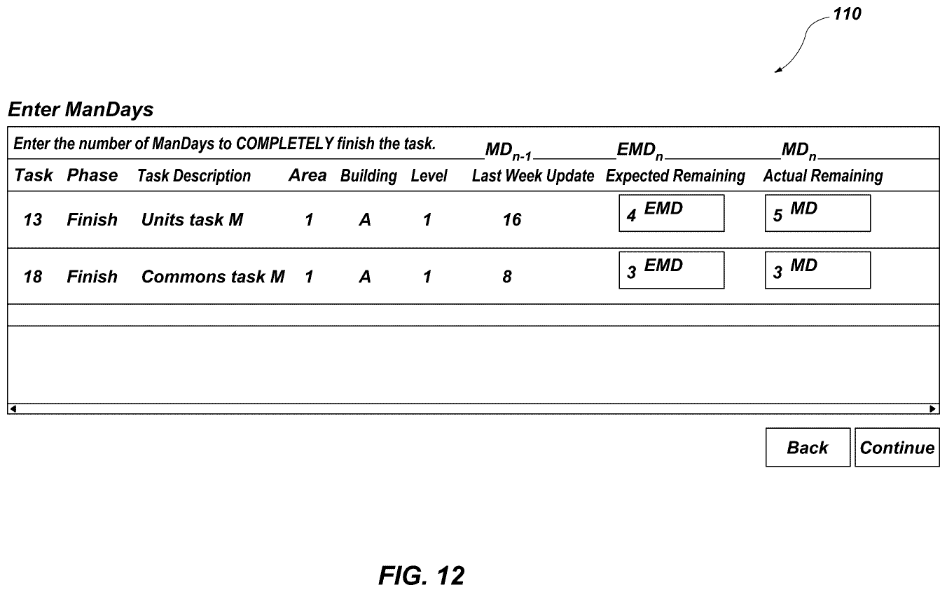

FIG. 12 illustrates one example for inputting remaining ManDays 110.

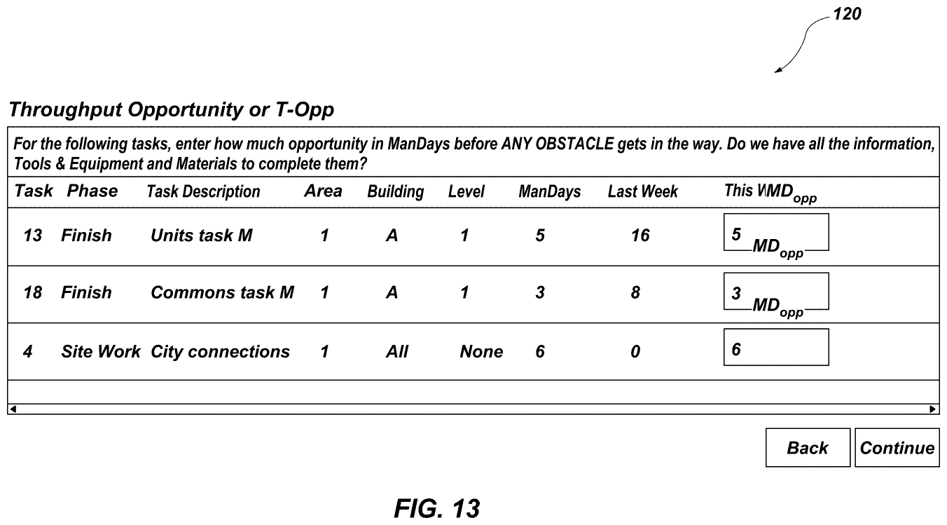

FIG. 13 illustrates one example of an updated Throughput Opportunity 120.

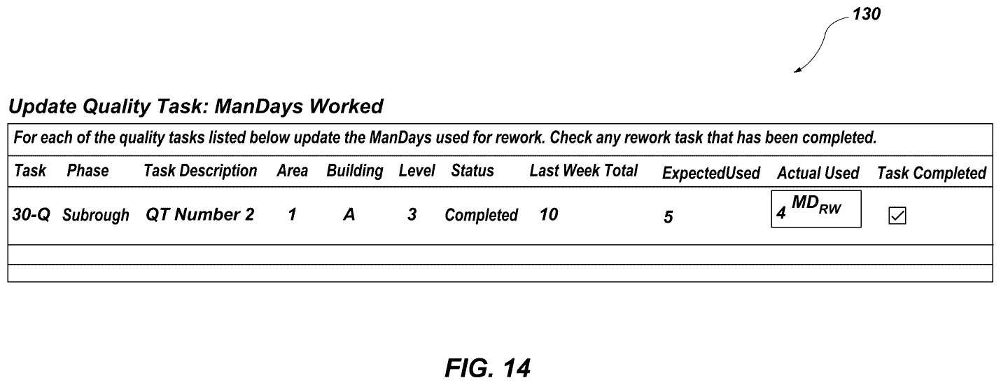

FIG. 14 illustrates one example of inputting or updating ManDays for reworks 130.

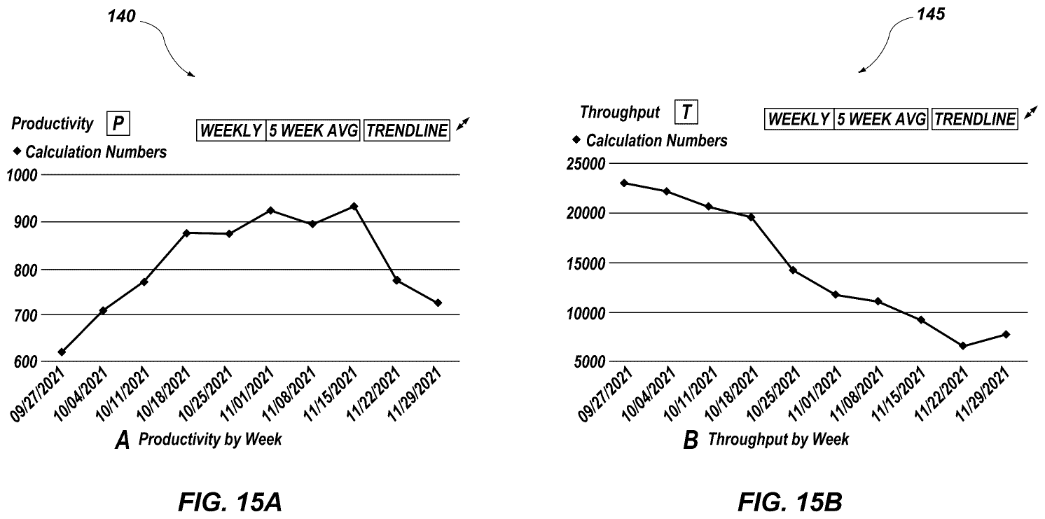

FIG. 15A illustrates a graph of productivity by week 140 and FIG. 15B illustrates a graph of throughput by week 145.

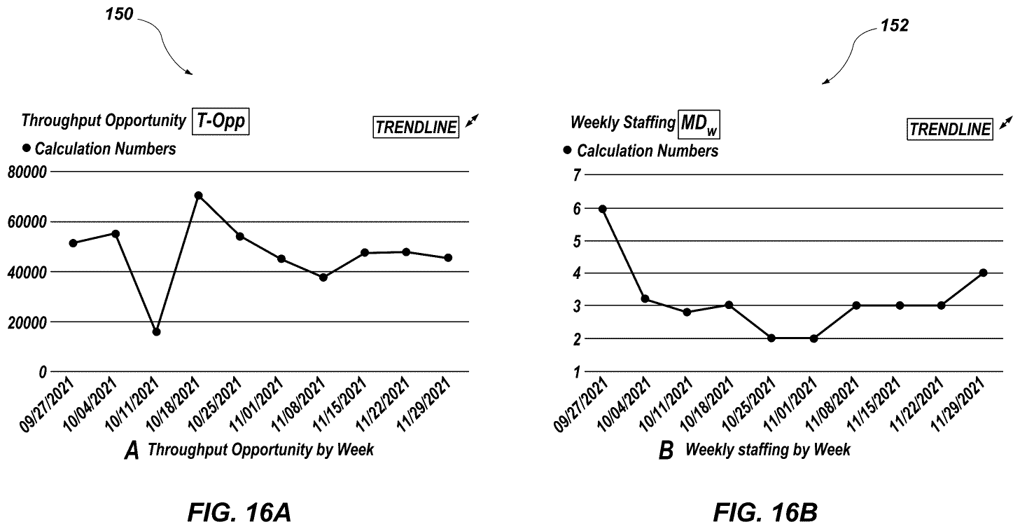

FIG. 16A illustrates a chart of Throughput Opportunity by week 150.

FIG. 16B illustrates a chart of Weekly Staffing 152.

FIG. 16C illustrates a chart of Project Completion by week 154.

FIG. 16D illustrates a chart of Through Capacity by week 156.

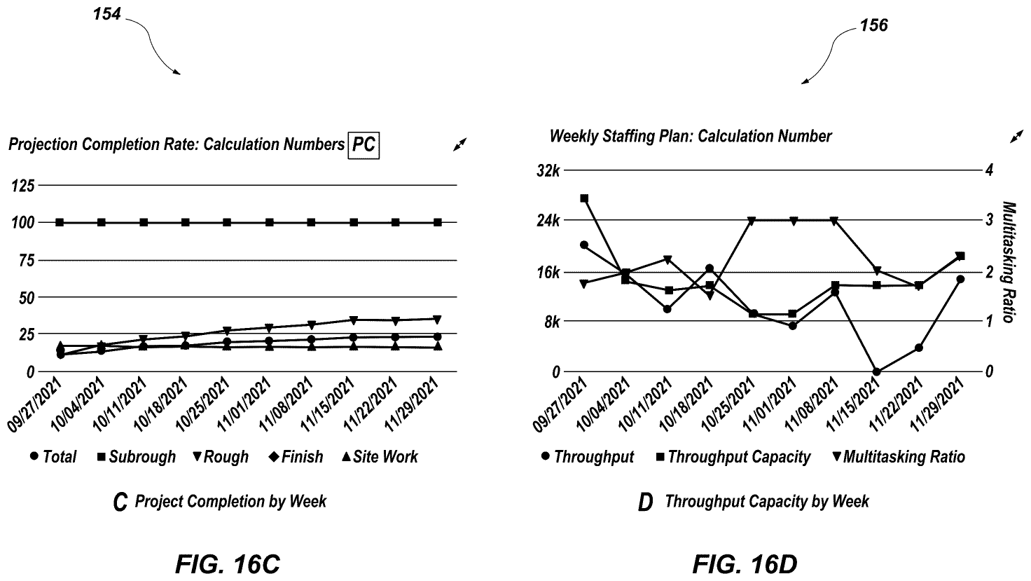

FIG. 17A illustrates a chart of Safety Consumed versus Project Completion 160.

FIG. 17B illustrates a chart of Poor Quality Costs resulting from rework 165.

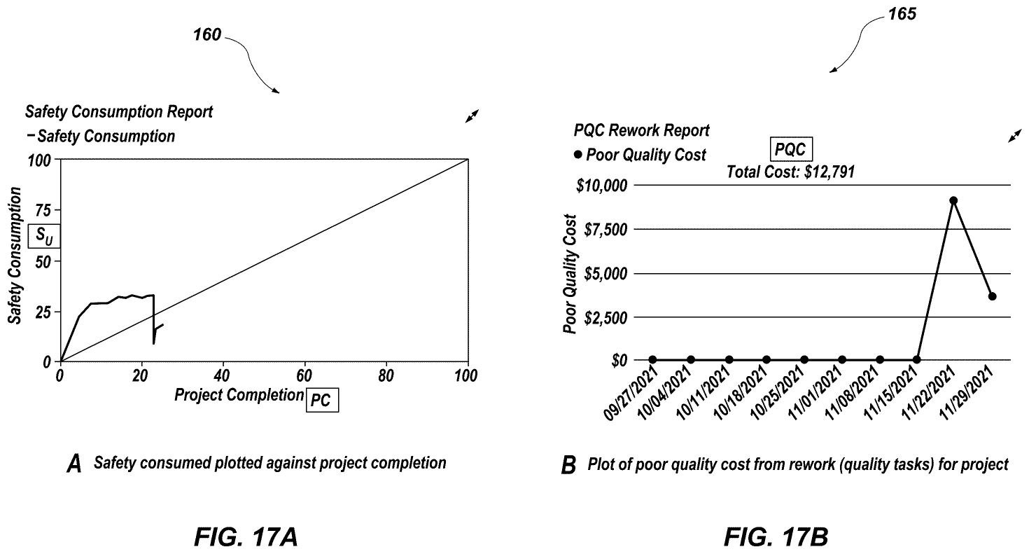

FIG. 18 illustrates one example of company totals for Throughput and Opportunity 170.

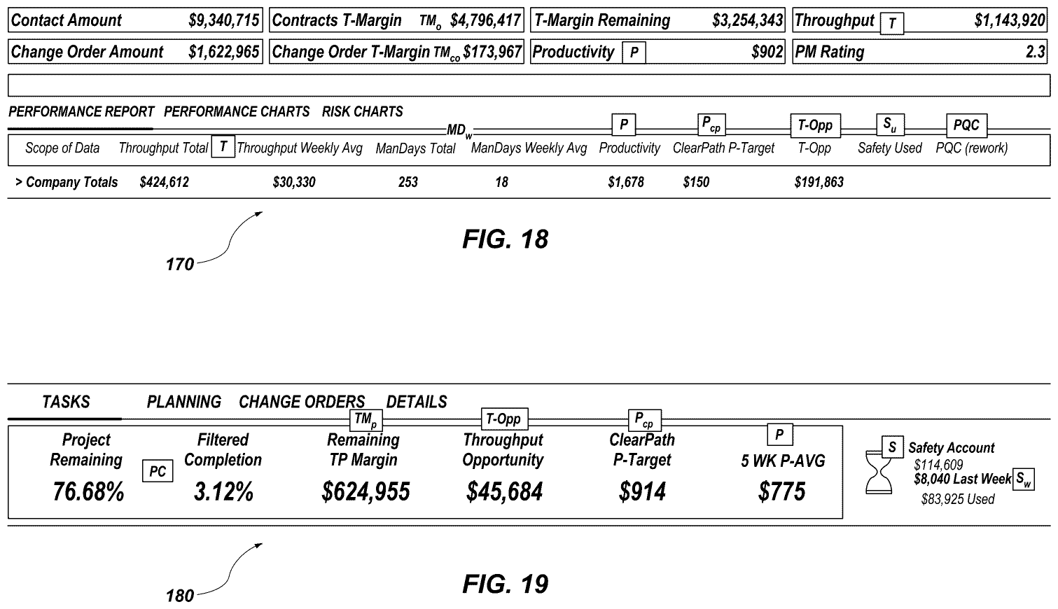

FIG. 19 illustrates one example of a project summary of outputs 180.

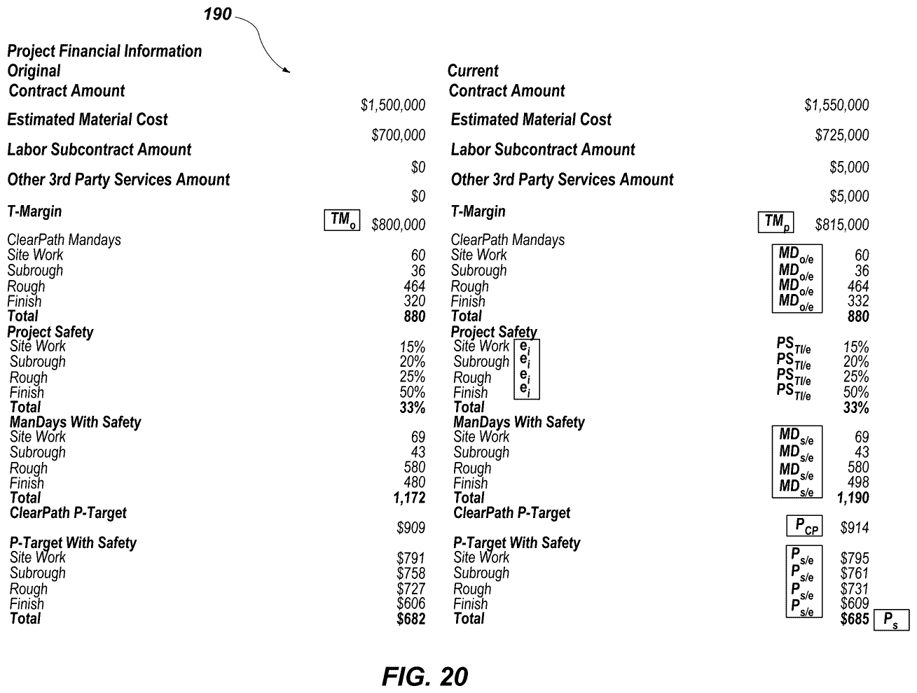

FIG. 20 illustrates one example of contract and change order outputs 190.

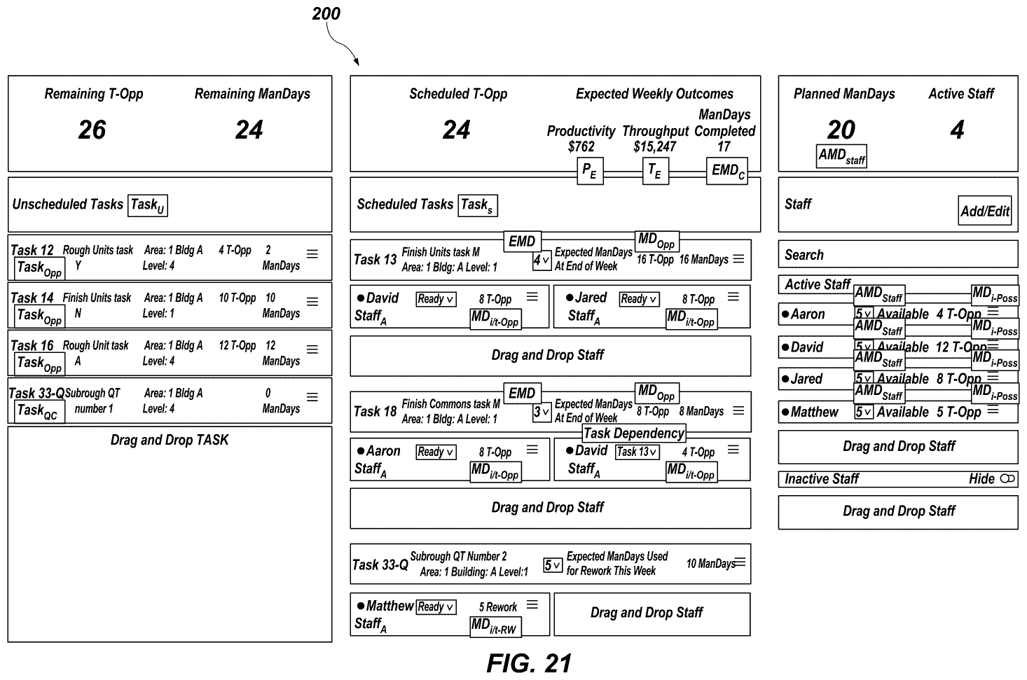

FIG. 21 illustrates one example of an interface for building a Weekly Plan 200.

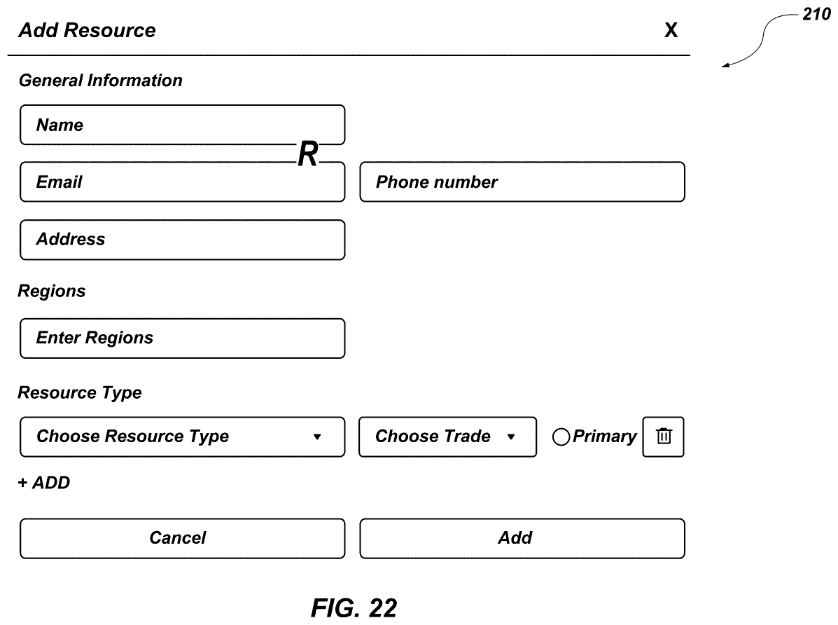

FIG. 22 illustrates examples of various inputs that may be required to create a resource 210.

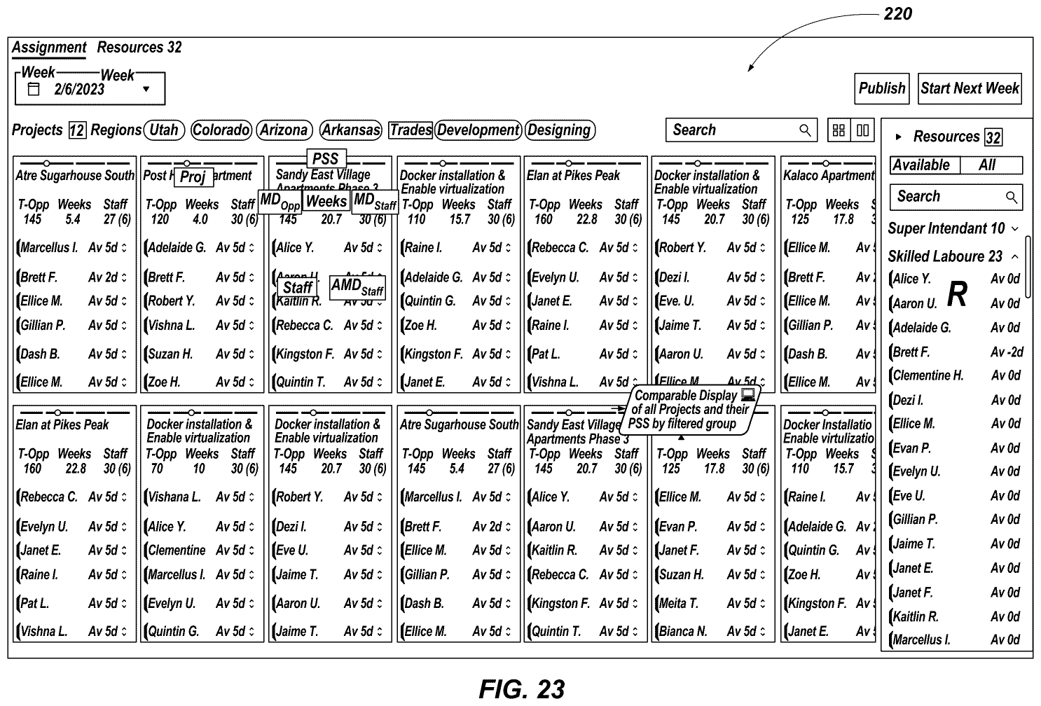

FIG. 23 illustrates one example of an interface to build a Weekly Resource Plan 220.

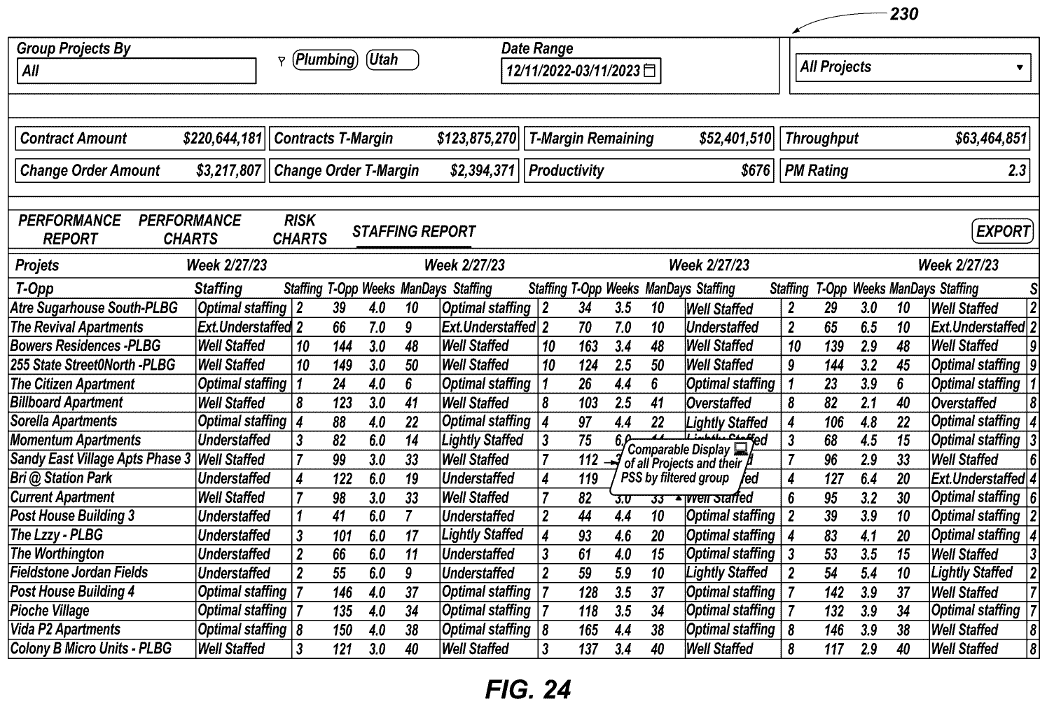

FIG. 24 illustrates one example of a Staffing report 230.

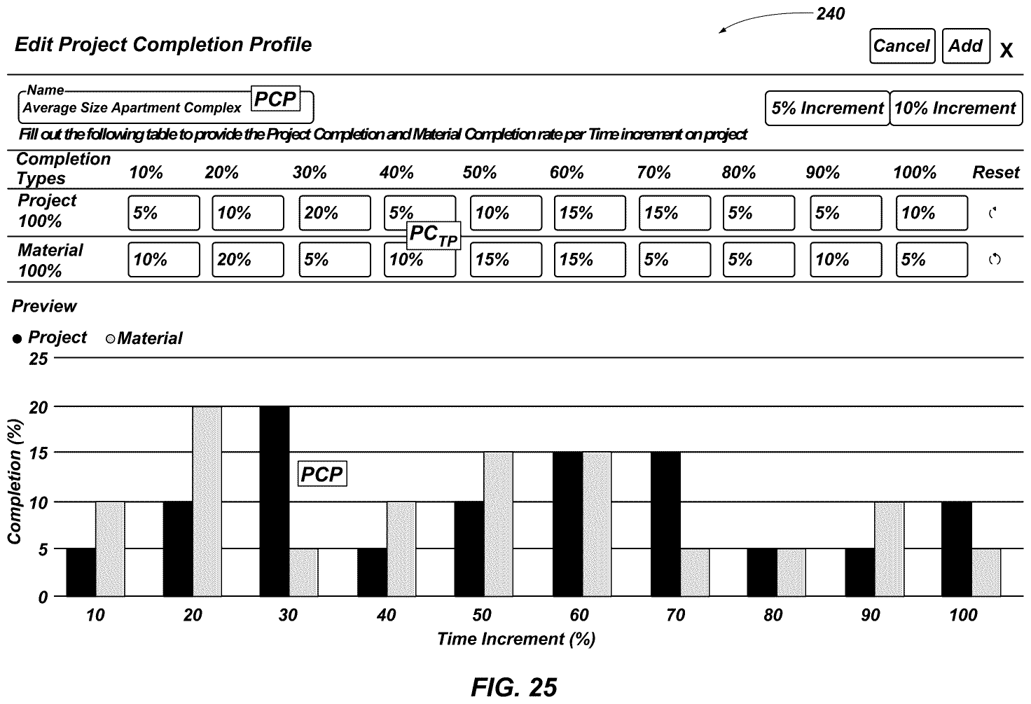

FIG. 25 illustrates one example of an interface for building a Project Completion Profile 240.

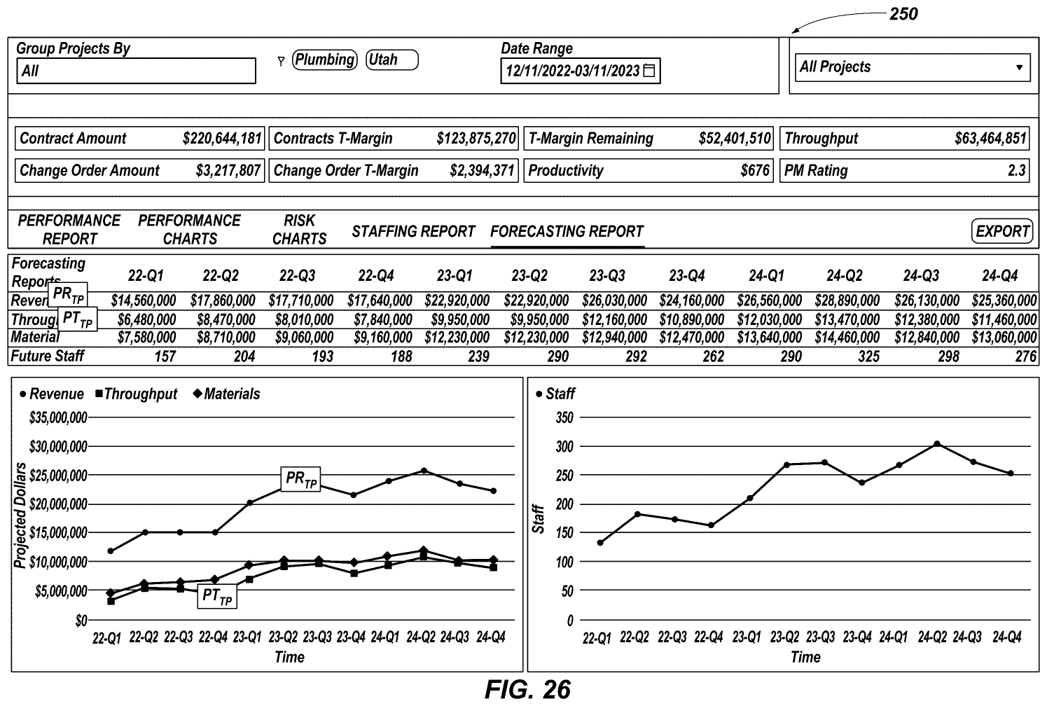

FIG. 26 illustrates one example of a report detaining projected revenue and Throughput for a company 250.

FIG. 23 illustrates whether there is overstaffing or understaffing and the bar can show how a particular project has been staffed.

FIG. 23 illustrates how staff is being allocated by staff member (e.g., could include skill set needed for a job in case a more skilled worker was doing a lower skilled job).

Although the foregoing description provides many specifics, these should not be construed as limiting the scope of the description or its embodiments or methods or of any of the appended claims, but merely as providing information pertinent to some specific embodiments that may fall within the scopes of the description and the appended claims. Additionally, while the system described herein may have been written to derive from a “beginning” of a project, it will be appreciated that the system is capable and may function by onboarding mid-project or with any project already in progress. Features from different embodiments may be employed in combination. In addition, other embodiments of the description may also be devised which lie within the scopes of the description and the appended claims. The scope of the description is, therefore, indicated and limited only by the appended claims and their legal equivalents. All additions, deletions, and modifications to the description, as disclosed herein, that fall within the meaning and scopes of the claims are to be embraced by the claims.

What is claimed:

1. A system for increasing project Productivity utilizing TOC principles in project management, the system comprising:
a processor programmed with predetermined logic sequences for measuring the throughput opportunity for a task or a project, the processor configured to:
receive a first input signal of the project or the task with an initial set of values;
process the initial set of values;
signal a control unit within the processor to produce an initial output utilizing the first set of values showing clear path values to complete a project or task;
the clear path values established by a user providing resource consumption estimates
receive a second input signal with a second set of values;
process the second set of values;
signal the control unit to produce a second output utilizing the first set of values and second set of values to provide an updated Throughput Opportunity of the project and updated values of what is remaining on the task and the project, wherein the system accurately measures Throughput and Productivity of project resources; and
a user interface to provide an initial set of values and a second set of values as well as real time updates.

2. The system of claim 1, wherein the initial set of values comprise:
Project revenue and Throughput Margin, number of ManDays to complete the projector the tasks; and the ClearPath Productivity.

3. The system of claim 2, wherein processor is configured to:
signal a memory unit within the processor to process the initial set of values through at least one first formula to produce the first output, the first output comprising:
a current Throughput Opportunity and Productivity in the project;
a current capacity value of the current staffing; and a Throughput value being produced by the current capacity value.

4. The system of claim 1, wherein the second set of values comprise:
ManDays worked per interval of time;
remaining ManDays at the interval of time; or
ManDays used for rework.

5. The system of claim 4, wherein processor is configured to:
signal a memory unit within the processor to process the second set of values through at least one second formula to produce the second output, the second output comprising:
a Throughput value of the project;
a Productivity value of the project;
a Project Completion;
a Throughput capacity value; and
a Throughput Opportunity value of the project;
total cost of rework; and
the project Safety used and remaining Safety budget and other risk management parameters.

6. The system of claim 1, wherein the processor is configured to produce a Project Completion Profile based on one or more of the initial set of values and the second set of values.

7. The system of claim 6, wherein the Project Completion Profile comprises a variety of forecasts.

8. The system of claim 7, wherein the variety of forecasts comprises Projected Revenue by time period (Month, quarter, year) for a project.

9. The system of claim 7, wherein the variety of forecasts comprises Projected Throughput by time period (Month, quarter, year) for a project.

10. The system of claim 7, wherein the variety of forecasts comprises projected Revenue and Throughput for a company.

11. The system of claim 7, wherein the variety of forecasts comprises Projected Revenue by time period (Month, quarter, year) for a project, Projected Revenue by time period (Month, quarter, year) for a project, and projected Revenue and Throughput for a company.

12. The system of claim 1, wherein the processor is configured to create one or more resources, the one or more resources corresponding to (a) a type of resource, (b) a capacity, and/or (c) a skill level.

13. The system of claim 1, wherein the processor is configured to strategically manage a resource pool for a group of projects in a way to meet at least one schedule requirement while simultaneously increasing Productivity.

14. A computer readable medium comprising:
a system for increasing project Productivity utilizing TOC principles in project management, the system comprising
a processor preprogrammed with logic sequences for measuring a throughput opportunity for a task or a project, the processor configured to:
receive a first input signal of the project or the task with a first number of ManDays;
process the first number of ManDays;
signal a control unit within the processor to produce an initial output utilizing the first set of ManDays showing ClearPath values to complete a project or task;
the ClearPath values, initially established by a user providing resource consumption estimates,
receive a second input signal with a second set of ManDays;
process the second set of ManDays;
signal the control unit to produce a second output utilizing the first set of ManDays and second set of ManDays to provide an updated values of what is remaining on the task or project and updated throughput opportunity of the task or project , wherein the system accurately measures Throughput and Productivity of project resources; and
a user interface to input a first set of ManDays and a second set of ManDays; wherein the user interface also showcases real time updates.

15. The computer readable medium of claim 14, wherein processor is configured to:
signal a memory unit within the processor to process the first set of ManDays through at least one first formula to produce the first output, the first output comprising:
a current Throughput Opportunity and Productivity in the project or task;
a current capacity value of the current staffing; and a Throughput value being produced by the current capacity value.

16. The computer readable medium of claim 14, wherein the processor is configured to:
signal a memory unit within the processor to process the second set of ManDays through at least one second formula to produce the second output, the second output comprising:
a Throughput value of the project;
a Productivity value of the project;
a Project Completion;
a Throughput capacity value; and
a Throughput Opportunity value of the project;
total cost of rework; and
the project Safety used and remaining Safety budget and other risk management parameters.

17. The computer readable medium of claim 14, wherein the second set of ManDays is an updated set of ManDays.
